(19) United States
(12) Patent Application Publication
(10) Pub. No.: US 2015/0340024 A1
(43) Pub. Date: Nov. 26, 2015

(54) Language Modeling Using Entities

(71) Applicant: Google Inc., Mountain View, CA (US)

(72) Inventors: Vladislav Schogol, Brooklyn, NY (US); Pedro J. Moreno Mengibar, Jersey City, NJ (US)

(21) Appl. No.: 14/708,987

(22) Filed: May 11, 2015

Related U.S. Application Data
(60) Provisional application No. 62/002,509, filed on May 23, 2014.

(51) Int. Cl. G10L 15/06; G10L 15/18; G10L 15/26

(52) U.S. Cl. CPC G10L 15/063; G10L 15/26; G10L 15/18

(57) ABSTRACT

Among other things, this document describes a computer-implemented method. The method can include obtaining a plurality of text samples. For each of one or more text samples in the plurality of text samples, the text sample can be annotated with one or more labels that indicate respective classes to which one or more terms in the text sample are assigned, wherein annotating the text sample comprises determining that at least one term in the text sample corresponds to a first entity in a data structure of interconnected entities and determining a classification of the first entity within the data structure of interconnected entities. The method can include generating a class-based training set of text samples. A class-based language model can be trained using the class-based training set of text samples. A plurality of class-specific language models can be trained.

### CROSS-REFERENCE TO RELATED APPLICATIONS

This application claims priority to U.S. Provisional Application Ser. No. 62/002,509, filed on May 23, 2014, the entire contents of which are hereby incorporated by reference.

### TECHNICAL FILED

This document generally relates to language models.

### BACKGROUND

Speech recognition has become a widely adopted and frequently used mode of interacting with computing devices. Speech input may be more convenient and efficient than traditional input modes such as typing through a keyboard. For example, mobile computing devices may offer speech recognition services as an alternative input mode to typing characters through a virtual keyboard on a touchscreen. Some computing devices are configured to accept voice commands from a user as a shortcut to performing certain actions on the computing device. Voice commands and other speech can be transcribed to text using language models. Language models have been trained using samples of text in a language to improve accuracies of the language models. Language models are also used in applications such as optical character recognition and machine translation.

### SUMMARY

This document generally describes techniques for training language models using class-based training text samples and class-specific training text samples. Class-based training text samples include modified text samples in which particular terms in the text are replaced with class identifiers that represent classes for the particular terms. For example, book titles may be replaced with a book class identifier, and movies may be replaced with a movie class identifier. In some implementations, this document describes techniques for determining class identifiers based on a data structure of interconnected entities that represents a plurality of people, places, things, and ideas, along with their attributes, classes, and relationships. Terms in text samples can be determined to correspond to particular entities in such a data structure, and then a class may be identified based on the classification of the particular entities in the data structure. Once a collection of class-based training text samples is generated, they may be used to train a class-based language model. The specific terms that were replaced by class identifiers may be grouped into sets of class-specific text samples, which are then used to train respective class-specific language models. Both the class-based language model and one or more class-specific language models may be used to decode an input stream, such as to transcribe an utterance in a speech recognizer, for example.

In some implementations, a computer-implemented method includes obtaining a plurality of text samples. For each of one or more text samples in the plurality of text samples, the text sample can be annotated with one or more labels that indicate respective classes to which one or more terms in the text sample are assigned, wherein annotating the text sample includes determining that at least one term in the text sample corresponds to a first entity in a data structure of entities and determining a classification of the first entity within the data structure of entities. The data structure of entities can include representation of a plurality of entities and can define relationships among particular ones of the plurality of entities. The method can include generating a class-based training set of text samples by substituting the one or more terms in the one or more text samples with respective class identifiers for the one or more terms that correspond to the respective labels for the one or more terms. A class-based language model can be trained using the class-based training set of text samples. A plurality of class-specific language models can be trained. The method can further include performing speech recognition on an utterance using the class-based language model and at least one class-specific language model from among the plurality of class-specific language models.

These and other implementations can include one or more of the following features. The data structure of entities can be represented by a graph of interconnected nodes that correspond to respective entities represented in the data structure.

Determining the label for the at least one term in the text sample can include identifying multiple classifications for the first entity within the data structure, and selecting a particular classification from among the multiple classifications that the first entity is most strongly associated with.

The data structure of entities can map relationships among entities in the data structure and identify one or more attributes of particular ones of the entities in the data structure.

The method can further include determining that at least one term in a first text sample being annotated corresponds to a first attribute of one or more entities in the data structure of entities, wherein annotating the first text sample comprises determining a label for the at least one term in the second text sample based on the first attribute of the one or more entities in the data structure.

The method can further include generating a plurality of class-specific training sets of text samples using terms from the one or more text samples that were substituted out for the class identifiers in the class-based training set of text samples, wherein one or more class-specific language models from among the plurality of class-specific language models are trained using class-specific training sets of text samples.

The method can further include repeatedly re-training the plurality of class-specific language models using dynamically updated training sets of text samples.

The dynamically updated training sets of text samples can be used to repeatedly re-train the plurality of class-specific language models are generated using entities identified from a data structure of entities.

The data structure of entities can be an emergent data structure that reflects updated knowledge over time such that additional entities are identified from the data structure for at least some of the times that the updated training sets of text samples are generated.

Performing speech recognition on the utterance using the class-based language model and the at least one class-specific language model can include: transcribing, using the class-based language model, one or more sequences of terms in the utterance; identifying a particular term in the utterance that is adjacent to the one or more sequences of terms in the utterance that have been transcribed; determining, based on the one or more sequences of terms in the utterance that have been transcribed, one or more classes to which the particular term likely belongs; and transcribing the particular term using the at least one class-specific language model, wherein the at least one class-specific language model is selected based on the one or more classes to which the particular term is determined to likely belong.

The one or more classes to which the particular term likely belongs can be determined further based on one or more contextual signals associated with the utterance other than content of the utterance.

Transcribing the particular term using the at least one class-specific language model can include determining that the particular term is an entity or an attribute of an entity in a data structure of entities.

Performing speech recognition on the utterance can include generating a transcription of the utterance and labeling one or more terms in the transcription based on one or more class-specific language models that were used to transcribe respective ones of the one or more terms.

The one or more terms in the transcription can be labeled with respective classes for the one or more terms that correspond to classes of entities in a data structure of entities.

In some implementations, one or more computer-readable devices can have instructions stored thereon that, when executed by one or more processors, cause performance of operations. The operations can include obtaining a plurality of text samples; for each of one or more text samples in the plurality of text samples, annotating the text sample with one or more labels that indicate respective classes to which one or more terms in the text sample are assigned, wherein annotating the text sample comprises determining that at least one term in the text sample corresponds to a first entity in a data structure of entities and determining a classification of the first entity within the data structure of entities, wherein the data structure of entities includes representations of a plurality of entities and defines relationships among particular ones of the plurality of entities; generating a class-based training set of text samples by substituting the one or more terms in the one or more text samples with respective class identifiers for the one or more terms that correspond to the respective labels for the one or more terms; training a class-based language model using the class-based training set of text samples; training a plurality of class-specific language models; and performing speech recognition on an utterance using the class-based language model and at least one class-specific language model from among the plurality of class-specific language models.

These and other implementations can include one or more of the following features.

The data structure of entities can be represented by a graph of interconnected nodes that correspond to respective entities in the data structure.

Performing speech recognition on the utterance using the class-based language model and the at least one class-specific language model can include transcribing, using the class-based language model, one or more sequences of terms in the utterance; identifying a particular term in the utterance that is adjacent to the one or more sequences of terms in the utterance that have been transcribed; determining, based on the one or more sequences of terms in the utterance that have been transcribed, one or more classes to which the particular term likely belongs; and transcribing the particular term using the at least one class-specific language model, wherein the at least one class-specific language model is selected based on the one or more classes to which the particular term is determined to likely belong.

Transcribing the particular term using the at least one class-specific language model can include determining that the particular term is an entity or an attribute of an entity in a data structure of entities.

In some implementations, a system can include one or more computers configured to provide a data structure, an entity classifier, one or more corpora of text samples, a named entity recognition engine, a training sample generator, and a training engine.

The data structure can include representations of a plurality of entities that maps relationships among particular ones of the plurality of entities. The entity classifier can assign particular entities from among the plurality of entities in the data structure to one or more respective classes. The named-entity recognition engine can identify particular terms in a first set of text samples that correspond to entities represented in the data structure. A training sample generator can generate a training set of text samples by replacing the particular terms in the first set of text samples with class identifiers that indicate respective classes for the particular terms that are determined based on the classes that the entity classifier has assigned to the entities represented in the data structure that correspond to the particular terms. A training engine can generate one or more language models using the training set of text samples.

These and other implementations can include one or more of the following features. The training engine can generate a class-based language model using the training set of text samples and one or more class-specific language models using the particular terms that were substituted out of the training set of text samples.

### BRIEF DESCRIPTION OF THE DRAWINGS

FIG. 1 depicts a conceptual diagram of an example process for using entities in a data structure to train a class-based language model.

FIG. 2 depicts an example system for training and running a class-based language model and class-specific language models using entities identified from a data structure.

FIG. 3 depicts a flowchart of an example process for training a class-based language model and one or more class-specific language models based on entities from a data structure of interconnected entities.

FIG. 4 depicts a flowchart of an example process for using a class-based language model and one or more class-specific language models in a speech recognizer.

FIG. 5 depicts an example data graph representing a data structure of interconnected entities.

FIG. 6 depicts an example portion of a data structure of interconnected entities and representations of data therein.

FIG. 7 depicts an example of a computing device and a mobile computing device that can be used to implement the techniques described in this paper.

Like reference numbers and designations in the various drawings indicate like elements.

### DETAILED DESCRIPTION

This document generally describes techniques for training and using class-based language models. Techniques are described for generating class-based language models using, for example, training sets of text samples in which particular terms have been replaced by class identifiers that correspond to respective classes for the particular terms. In some implementations, the terms that were substituted out of the training set of text samples can be grouped by class, and the groups may then be used to train respective class-specific language models. For example, an original text sample that reads “Michelle and Bob bought tickets for the concert in San Jose yesterday” may be modified to generate a class-based training sample, “$person_name and $person_name bought tickets for the concert in $city yesterday.” The class-based training sample can be used with other class-based training samples to train a class-based language model, and the replaced terms (Michelle, Bob, and San Jose) can be used to generate respective class-specific language models for people names and cities. The trained language models may then be used together during runtime to decode new instances of data, such as to perform speech recognition, machine translation, or optical character recognition.

In some implementations, the classes for the terms in the training set of text samples are determined by referencing a data structure of interconnected entities. Terms in the text samples may be determined to correspond to entities in the data structure. Once an entity has been identified for a particular term, a pre-determined class for the entity in the data structure can be used as the class identifier to replace the particular term in the class-based training sample. For example, in the sentence, “Michelle and Bob bought tickets for the concert in San Jose yesterday,” a named-entity recognition engine may process the sentence to determine that San Jose as used in the sentence is most likely referring San Jose, Calif., which is an entity represented in the data structure. Because San Jose, Calif. is known to be a city in the data structure, the “city” class may be identified for San Jose in the training text sample, and “San Jose” may then be grouped among other cities for training a city-specific language model.

The techniques described herein may achieve one or more advantages. For example, highly effective language models may be trained that are sensitive to the dynamic nature of various classes. Effective language models generally represent not only the syntactic structure of a language, but are also robust and accurate when confronted with terms from a very large body of knowledge, such as terms representing real-world entities and other concepts. Even more, an effective language model may take into account the relationships among entities, and the surrounding context in which those entities are likely to occur. According to the techniques described herein, an effective language model that meets these objectives can be realized by offloading some of the knowledge representation requirements from the core of the language model to a knowledge database, or to another type of data structure, which is maintained separately from the core language model. In this way, far fewer text samples may be required to train a robust, accurate language model than would otherwise be required in order to achieve a desired level of performance.

Because the knowledge database may be maintained at least partially independent of the language model, the language model can leverage changes within the knowledge database without the need to constantly re-train the language model from the ground up to incorporate such changes. This can be beneficial, because the knowledge database may evolve at a much greater pace than the syntactic structure of a language. For example, a language model that has been trained with a $movies class may refer to a list of movies within the knowledge database. The list of movies may be dynamically updated within the knowledge database every day or week, for example, but the language model need not be re-trained to account for the addition of every new movie. Instead, the language model may simply refer to the knowledge database (or to another data structure derived from the knowledge database) to identify which titles fall within the movie class. Moreover, the knowledge database may include context or other information about the movies, which the language model may use to identify other terms in an input stream. For example, if the movie “Independence Day” is recognized, then the language model may weight actor “Will Smith,” who stars in “Independence Day,” more highly than other actors within the class, based on information identified from the knowledge database. The language model may thus reference the knowledge database to account for context associated with different entities and class terms.

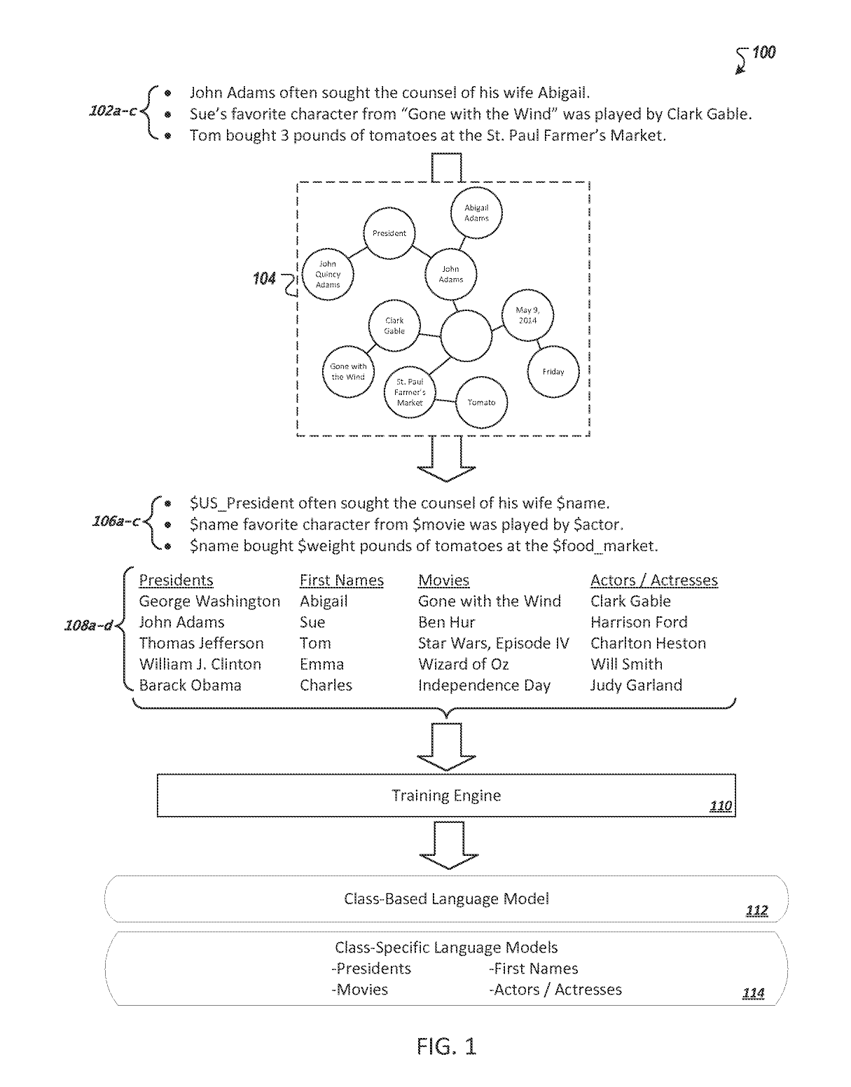

With reference to FIG. 1, a conceptual diagram is shown of an example process 100 for using entities in a data structure to train a class-based language model. The process 100 begins with an original set of text samples 102a-c. The three text samples 102a-c depicted in FIG. 1 may be only a representative subset of a much larger set of text samples that are obtained for training the language model 112. The text samples 102a-c may be obtained from one or more corpora. In some implementations, the text samples 102a-c may be obtained from query logs, speech recognition logs, message logs, publicly accessible resources such as web pages and other electronic documents, or any combination of these.

The text samples 102a-c may include references to one or more people, places, things, or ideas. For example a first of the text samples 102a-c, “John Adams often sought the counsel of his wife Abigail,” includes references to President John Adams and his wife, First Lady Abigail Adams. A second of the text samples 102a-c, “Sue's favorite character from “Gone with the Wind” was played by Clark Gable, includes references to a person named Sue, the movie “Gone with the Wind,” and actor Clark Gable. The third of the text samples 102a-c, “Tom bought 3 pounds of tomatoes at the St. Paul Farmer's Market,” includes references to a person named Tom, a weight of tomatoes, and a food market.

The text samples 102a-c thus include various specific terms that belong to broader classes of terms. The class of terms may be informative to the selection and sequence of other terms in the text sample. For example, in the second of the text samples 102b, the structure of the text sample could equally apply to any movie and actor, not just “Gone with the Wind” and “Clark Gable.” For instance, a text sample would make similar sense if it read “Bill's favorite character from Star Wars was played by Harrison Ford.” Accordingly, the process 100 can generate a plurality of class-based training text samples in which particular terms that are specific instances of classes are substituted with class identifiers. Class-based training samples 106a-c show example transformations of the original text samples 102a-c. For example, the original text sample 102a, “John Adams often sought the counsel of his wife Abigail,” is used to generate class-based training sample 106a, “$US_President often sought the counsel of his wife $name.” The other class-based training samples 106b-c are generated based on the original text samples 102b-c, respectively.

In order to accurately identify terms in the original text samples that are specific instances of a class of terms, the process 100 can reference a data structure 104 of interconnected entities. The data structure 104 may store information pertaining to a plurality of persons, places, things, and ideas. In some implementations, the data structure 104 may organize information around entities. Particular people, places, things, and ideas may be represented in the data structure as entities. One or more of the entities in the data structure may be associated with one or more respective attributes, and one or more of the entities in the data structure may be connected. For example, as shown in the data structure 104, entities are provided for John Adams, Abigail Adams, John Quincy Adams, Clark Gable, Gone with the Wind, the St. Paul Farmer's Market, and others. The process 300 determines that terms in the original text samples 102a-c likely correspond to entities in the data structure 104.

Entities in the data structure 104 can be classified into one or more classes. For example, John Adams may be classified as a President, Founding Father, lawyer, and person. Based on the classifications of the entities in the data structure 104, the corresponding terms in the text samples 102a-c can be replaced with class identifiers. In original text sample 102b, for example, the process 100 uses the classification of Gone with the Wind as a movie and the classification of Clark Gable as an actor in data structure 104 to generate the class-based training sample 106b, “$name favorite character from $movie was played by $actor.” The specific terms substituted out of original text samples 102a-c, along with additional names of entities in respective classes in data structure 104, may be organized into class-specific sets of text samples 108a-d. For example, John Adams is added to a presidents class-specific set of text samples 108a, along with other presidents identified within the class of presidents from data structure 104.

The process 100 then uses a training engine 100 to train a class-based language model 112 and one or more class-specific language models 114a-d. Particular training engine implementations are discussed further below. The class-based language model 112 can be trained based on text samples in the class-based training set of text samples 106, and the class-specific language models 114a-d can be trained based on text samples in respective class-specific training sets of text samples 108a-d. The resulting language models 112, 114a-d, may be used in various applications such as speech recognition, optical character recognition, and machine translation.

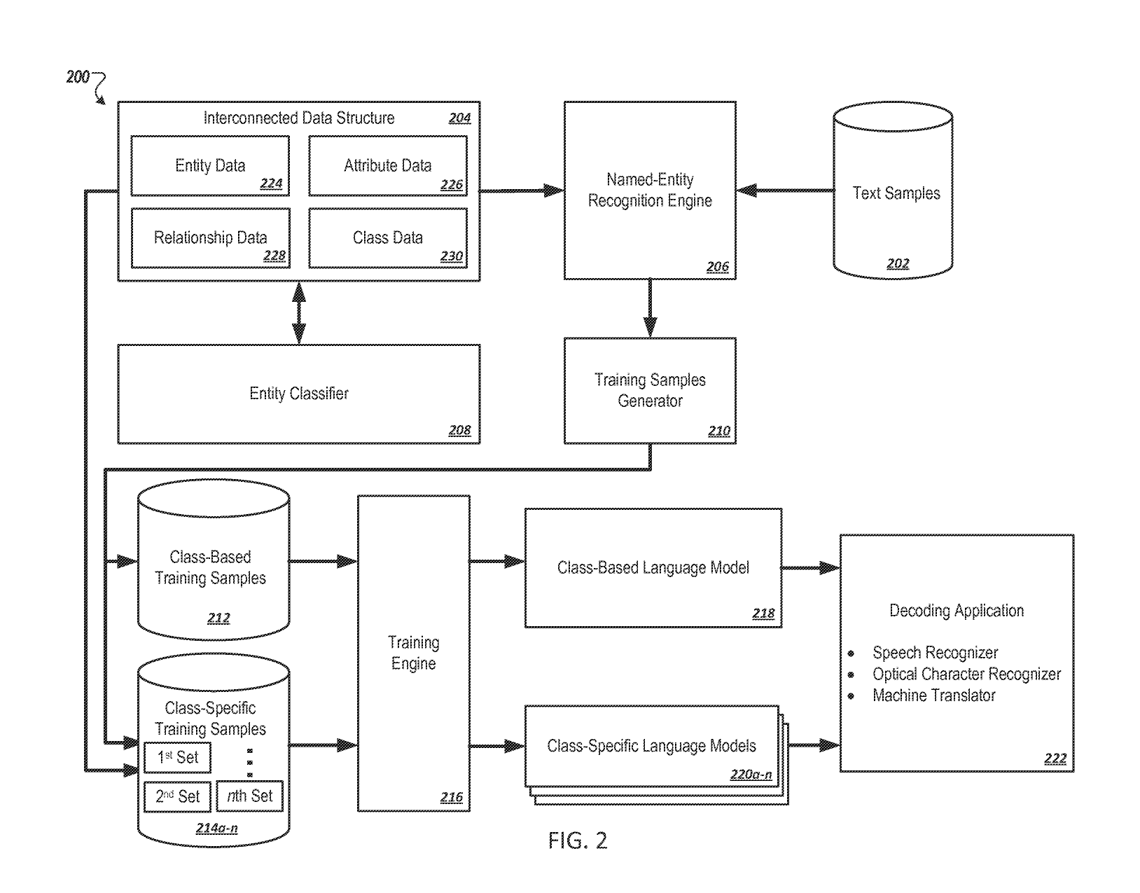

FIG. 2 depicts an example system 200 for training and running a class-based language model and class-specific language models using entities identified from a data structure. The system 200 generally includes an original text samples repository 202, a named-entity recognition engine 206, an interconnected data structure 204, an entity classifier 208, a class-based training samples repository 212, one or more class-specific training sample repositories 214, a language model training engine 216, a root language model 218, one or more class-specific language models 220a-n, and a decoding application 222. Generally, the system 200 can be configured to train a root language model 218 using class-based training samples that include class identifiers corresponding to classes of entities in the data structure 204. Class-specific language models 220a-n may also be trained based on terms that were identified in the original text samples as corresponding to particular entities, and also based on additional entities in the data structure 204 within particular classes. One or more of the class-based language model 218 and the class-specific language models 220a-n may be used in different applications such as speech recognition, optical character recognition, and machine translation. In some implementations, the system 200 may be configured to carry out operations from process 300 or process 400, for example, which are described in detail further below.

The original text samples repository 202 include a plurality of text samples that have been obtained from one or more sources. The text samples in repository 202 may be a representative set of text samples that reflect how sequences of terms are used in a particular language. Some or all of the text samples may be obtained from data logs that capture how sentences and other sequences of terms have been constructed in a language. For example, the text samples may be obtained from any combination of sources including search query logs, speech recognition logs, and messaging logs. In some implementations, text samples may be obtained from public electronic resources such as web pages, blogs, books, periodicals, online documents, and the like. Text samples may also be manually or automatically generated for the purpose of being used in training a language model. In some implementations, the text samples in repository 202 may be randomly selected in a manner that achieves a desired distribution of text samples with one or more features. For example, text samples may be selected for inclusion in repository 202 so as ensure inclusion of at least a given breadth and depth of certain terms or sequences of terms.

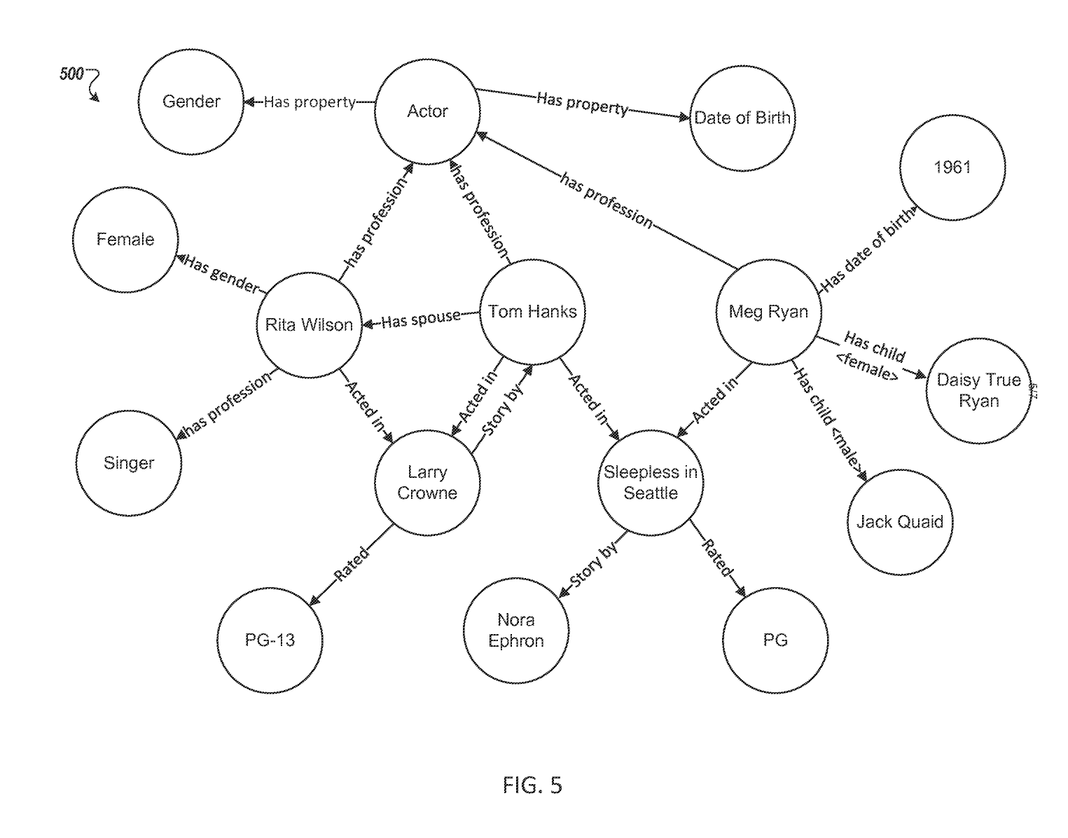

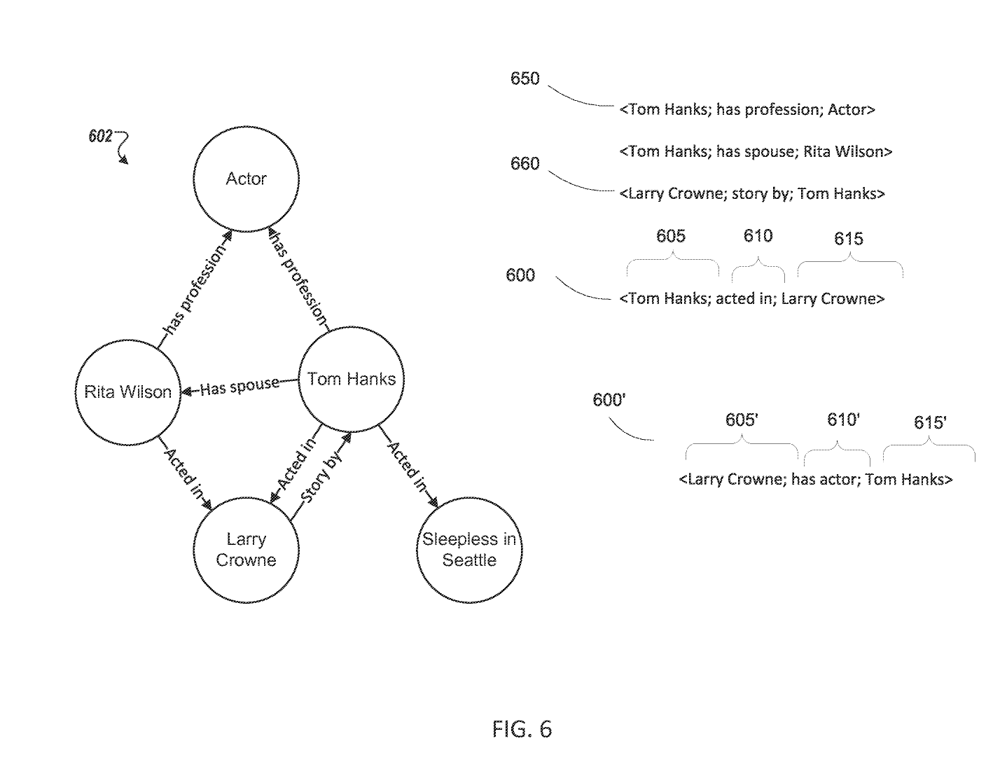

The data structure 204 may include a plurality of interconnected entities that represent people, places, things, or ideas, along with information that specifies attributes and relationships among the entities. For example, the data structure may include entities for books, movies, celebrities, politicians, landmarks, historical events, toys, geopolitical entities, and more. Each entity may be associated with one or more attributes and may be connected to one or more other entities in the data structure 204. For example, the data structure may include an entity that represents Barack Obama. The Barack Obama entity in data structure 204 may be associated with many attributes that capture relevant information about Barack Obama such as birth date, inauguration date, profession, and more. The Barack Obama entity may then be connected to one or more other entities. For instance, the data structure 204 may include entities for Michelle Obama, Hillary Clinton, and Harvard Law School. These entities may be interconnected. For example, the data structure 204 may be represented as a graph of nodes that correspond to entities and edges that connect the nodes, where the edges indicate the nature of the relationship of connected entities. Thus, entity nodes for Barack Obama and Michelle Obama may be connected by an edge that indicates that they are spouses. Hillary Clinton may be connected to Barack Obama due to her being Secretary of State in Barack Obama's administration, and Harvard Law school is the law school that Barack Obama attended. The data structure 204 may be generated according to a pre-defined ontology, such as using data triples that specify an entity, attribute, and attribute value. The attribute value may be another entity (e.g., Harvard Law School), or may be a non-entity (e.g., the value for Barack Obama's height or weight). In some implementations, the data structure 204 may be structured in a similar manner to the example data structures 500 and 602 that are depicted in FIGS. 5 and 6, respectively.

The data structure 204 may be curated to include information about all types of entities in the real world, whether famous or obscure. In some implementations, the data structure 204 may be curated manually. For example, a group of people tasked with maintaining the data structure 204 may manually specify entities and their attributes and relationships. Additionally or alternatively, the data structure 204 may be automatically curated by a computer system using certain algorithms that identify entities and related information based on information from various electronic resources. For example, web pages and electronic documents on the Internet may be crawled and the content of such pages or other documents analyzed to determine entities, relationships, and attributes. For instance, if thousands of documents are crawled that discuss Barack Obama's presidency, it can be confidently determined that Barack Obama is a person, a President, is married to Michelle Obama, and more. Because the nature of things in the real world are constantly changing and new things are constantly created, the data structure 204 may be constantly updated to capture increasing amounts of data and to reflect current, as well as historical, information about different entities.

Entities in the data structure 204 may be associated with one or more classes. The classes may be determined an entity classifier 208. In some implementations, the classes may reflect topics associated with the entities. For example, Barack Obama may be associated with topics such as presidents, politicians, authors, senators, lawyers, married men, and people. The entity classifier 208 may, in some implementations, generate topic scores that are associated with each topic for an entity and that indicate a likely relevance of each topic to the entity. For instance, Barack Obama's topic score for presidents may be much higher than his topic score for married men. Although Barack Obama is indeed a President of the United States and also a married man, in most contexts the presidency topic is more relevant. Topics and topic scores may be determined based on one or more factors including the frequency that topics are discussed in relation to particular entities in various resources. Topics may also be manually curated. Classes may be based on topics or other classifications. For example, Barack Obama may be classified as a president, politician, author, senator, lawyer, married man, and a person, or may be classified in other manners. In some implementations, topics and other classes may be arranged hierarchically. For example, the book “Hunger Games: Catching Fire” may be classified as fiction, which is a sub-class of books.

In some implementations, the interconnected data structure 204 may include one or more data repositories that store the data for the data structure 204. The data structure 204 may include an entity data repository 224, an attribute data repository 226, a relationship data repository 228, and a class data repository 230. The entity data repository 224 may include one or more items of information for each of the entities in the data structure 204, including unique entity IDs. For example, Barack Obama may be represented uniquely in the data structure by an ID (e.g., B3CCF24A) rather than his given name. Instead, “Barack Obama” may be an attribute value of entity ID B3CCF24A for a full name attribute. The attribute data repository 226 may store information relating to attributes of the entities, and the relationship data repository 228 may store information about how entities are connected in the data structure 204. The class data repository 230 stores topics or other class information for the entities in the data structure 204. For example, the class data repository 230 may identify that Barack Obama is a president and that the Golden Gate bridge is both a landmark and a bridge. The class data repository 230 may also store topic scores (class scores) for topics and classes associated with the entities. In some implementations, the class data repository may be stored outside of the data structure 204, such as in memory associated with the entity classifier 208. In some implementations, any of the entity data repository 224, attribute data repository 225, relationship data repository 228, and class data repository 230 may be implemented in one or more databases. In some implementations, data is stores in triples that identify an entity, relationship, and attribute value.

The named-entity recognition engine 206 is configured to identify classes for terms (or sequences of terms) of text samples from repository 202. In some implementations, the named-entity recognition engine 206 classifies terms based on known classifications of entities in the data structure 204 that correspond to such terms. For example, given a text sample that reads “My favorite book in the trilogy by Suzanne Collins was ‘Catching Fire,’” the named-entity recognition engine 206 may determine that Suzanne Collins is an author and that ‘Catching Fire’ is a book by Suzanne Collins. Thus, the original text sample may be labeled (annotated) by the named-entity recognition engine 206 as “My favorite book in the trilogy by <author> Suzanne Collins</author> was <book> ‘Catching Fire’ </book>.” The training samples generator 210 can then use the labeled output of the named-entity recognition engine 206 to generate a class-based training sample in which one or more of the labeled terms are replaced with class identifiers based on the labels. For example, in the above sentence, the training samples generator 210 may generate a class-based training sample with class identifiers: “My favorite book in the trilogy by $author was $book.” In some implementations, a class-based training sample may be generated directly from an original training sample without separately annotating the training sample. For example, the named-entity recognition engine 206 may analyze a text sample and replace particular terms with class identifiers without first labeling the text sample.

In some implementations, the named-entity recognition engine 206 identifies classes for terms in text samples based on known classifications of entities in the data structure 204. The named-entity recognition engine 206 may identify that terms correspond to entities in the data structure 204 in one or more ways. In some implementations, terms in a text sample may be specific enough that one or more entities can confidently be determined from individual terms themselves. For example, terms such as “Statue of Liberty,” “Barack Obama,” “Berlin Wall,” and others are highly suggestive of specific entities, and the named-entity recognition engine 206 may determine that such specific terms most likely are references, respectively, to New York's Statue of Liberty, President Barack Obama, and the Berlin Wall that was erected between Eastern and Western Germany. Even though there may be a small chance that these famous figures and landmarks were not actually the subjects of the terms in the text sample, the terms are so specific and well known that the presence of the terms in a text sample is enough to determine that they refer to the entities in the data structure 204 that correspond to the well-known figures. Other specific terms, such as addresses may not be well-known, but also may be specific enough to satisfy a threshold confidence that the specific terms correspond to particular entities.

The named-entity recognition engine 206 may also use other signals to identify entities that correspond to terms in text samples. In some implementations, the context of a text sample may inform the meaning and identification of particular terms in the text sample. For example, the sentence “I enjoyed reading the book ‘Catching Fire’” clearly indicates that the subject “Catching Fire” is a book from the terms “book” and “reading” in the text sample. Therefore, the named-entity recognition engine 206 can be sufficiently confident to determine that “Catching Fire” as used in the text sample corresponds to an entity in the data structure 204 for the Suzanne Collins novel of the same name, rather than, for example, the movie of the same name. In some implementations, n-gram models and bag of words models may facilitate using in-text context to classify terms and to correlate terms to entities in the data structure 204. For example, the named-entity recognition engine 206 may recognize that certain trigrams or other n-grams are frequently used with references to particular entities, or that the unordered distribution of terms from a bag of words model indicates particular entities.

The named-entity recognition engine 206 may also use non-content based context signals to identify classes and entities from the data structure 204. Non-content-based context signals can include any information associated with a text sample that is not derived from the text of the sample. For example, text samples that were obtained from query logs may be associated with user interaction data that indicates other queries a user submitted in a search session or that indicates particular search results that were selected by the user that were returned in response to the query. For instance, a text sample that originated from the query “What are the best museums in Washington?” may be associated with data that indicates a user selected search results related to Washington, D.C. rather than Washington state. Based on this user interaction data, the named-entity recognition engine 206 may assign a higher confidence score to the Washington, D.C. entity in data structure 204 than the Washington state entity. Because Washington D.C. is scored highest among all identified entities, the text sample may be labeled with a city, rather than state, class that corresponds to the Washington, D.C. entity in the data structure. In some implementations, combinations of signals may be used to determine entities and classes, including both text-based content signals and non-content based context signals (e.g., user interaction data).

The named-entity recognition engine 206 in some implementations may identify multiple entities, classes, or both for terms in text samples. In some implementations, multiple entities may be identified due to some degree of vagueness of the text sample. For example, the reference to “Hunger Games” is vague in the following text sample: “I received the Hunger Games for Christmas.” In this example, “Hunger Games” may refer to any of several books by Suzanne Collins, or may refer to a series of movie adaptations of the books. Each of the books and movies may be represented by respective entities in the data structure 204. In some implementations, confidence scores can be assigned to multiple different entities that are determined to potentially correspond to a term in a text sample. The named-entity recognition engine 206 may then select one or more of the multiple entities to label the term in the text sample with, so that one or more class identifiers are substituted for a particular term in a class-based training text sample. In some implementations, entities with the top n confidence scores may be selected as the basis for labeling classes of a term in a text sample. In some implementations, entities whose confidence scores satisfy a threshold confidence score may be selected. For example, the named-entity recognition engine 206 may identify entities for each of the books and movies in the Hunger Games series as potentially corresponding to the pair of terms “Hunger Games” within the text sample “I received the Hunger Games for Christmas.” The entities with the highest confidence scores may be the first book and the first movie in the trilogy, both named the “Hunger Games.” Therefore, the named-entity recognition engine 206 may use entities for both the book and the movie to label the “Hunger Games” in the text sample, from which a class-based training sample with multiple classes for the single pair of terms is used: “I received the [$book, $movie] for Christmas.”

In some implementations, the named-entity recognition engine 206 can determine a class based on information determined from the data structure 204 without identifying specific entities in the data structure 204. The named-entity recognition engine 206 may be configured to use both textual content and non-content signals to determine one or more classes for terms in a text sample, where the classes are determined based on classes of entities in the data structure 204. For example, the named-entity recognition engine 206 may have been trained to recognize that a particular series of terms is highly indicative of one or more different entities in the data structure 204 that belong to a common class. Rather than resolving which of the different entities that the particular series of terms belongs to, the named-entity recognition engine 206 may simply label the relevant term in the text sample with the class that each (or some) of the potential entities belongs to.

By identifying classes of entities from the data structure 204, the named-entity recognition engine 206 may be able to more accurately determine classes of terms in text samples used to train a language model. In some implementations, the named-entity recognition engine 206 may be configured to select a particular class among a plurality of related classes for a term in a text sample. Classes may be related in a number of ways, including hierarchically. The named-entity recognition engine 206 may select one or more classes in a hierarchy of classes with which to label a term in a text sample. For example, the entity for Bono, who is the lead singer for U2, may be classified in the data structure 204 as a singer, which is a sub-class of musician, which is a sub-class of male celebrities, which is a sub-class of males, which is a sub-class of persons. Given the text sample “Bono gave a fantastic performance last week,” the named-entity recognition engine 206 may label Bono as one or more of a singer, musician, male celebrity, man, and person depending on the level of generality desired. In some implementations, the most specific class may be labeled, and then at a later stage, by using the same hierarchy or other taxonomy of classes by which entities are classified in the data structure 204, a language model may be trained by determining one or more increasingly generic classes. For example, although the named entity recognition engine 206 may label Bono as being a singer, a class identifier may be substituted for Bono in the text sample for musician, celebrity, person, or a combination of these by referencing the taxonomy of classes.

The data structure 204 may be continuously evolving, expanding, or otherwise changing. In some implementations, new attributes and facts may be added to existing entities, entities may change classes, different classes may become more relevant for particular entities, and new entities may be added. The named entity recognition engine 206 may be tied into the data structure 204 so as to determine classes for terms in text samples that reflects a current or recently updated version of the data structure 204. Thus, as new people, places, things, and ideas represented by entities in the data structure 204 are added or otherwise changed, the changes can be reflected in the classifications in the text samples. For example, whereas the most-relevant class for the entity representing Michael Strahan may previously have been “professional athlete,” currently the most-relevant class may be “talk show host.” The change can be reflected in the named-entity recognition engine's 204 labeling. The named-entity recognition engine 206 in some implementations may determine a timestamp associated with a text sample to determine which class is most relevant. If the text sample was authored in 2004, then Michael Strahan may be labeled “professional athlete,” a text sample authored in 2014 may have Michael Strahan labeled “talk show host.”

The named-entity recognition engine 206 may be configured to distinguish static terms from dynamic terms in a text sample, and to label or cause to be substituted only dynamic terms. Static terms may be less specific terms that define the structure of a sentence, whereas dynamic terms are specific instances of a class of terms whose particular selection from among other terms in the class does not substantially impact the usage or sequence of other terms in a text sample. By replacing dynamic terms in text samples with class identifiers for those terms, a language model may be richly trained using far fewer text samples than what would otherwise be required in some implementations. For example, given the text sample “They were selling up to 15 pounds of tomatoes per customer at the market last week,” it is unlikely that text samples with the exact or similar text would be available to train a language model for a range of numbers representing the pounds of tomatoes (e.g., 9 pounds, 10 pounds, 13 pounds, etc.). Instead, the named-entity recognition module 204 may determine that “15” is an instance of the class “numbers,” or “weight,” and may label the text sample accordingly. In some implementations, the named-entity recognition engine 206 may determine a class for terms in a text sample that do not correspond to particular entities in the data structure 204. For example, in the text sample, “I called Mary to ask her to dinner,” there is no indication of a particular person named Mary who is being referred to in the text sample, an entity representing a particular Mary may not be determined from the data structure 204. However, the named entity recognition engine 206 may still label Mary by recognizing that Mary is generally a name, a first name, or a person, for example.

The system 200 may further include a class-based training samples repository 212 and one or more class-specific training samples repositories 214a-n. The class-based training samples repository 212 includes a plurality of text samples that having labels or class identifiers that identify classes of particular terms in the text samples. All or some of the text samples in the class-based training samples repository 212 may be class-based training samples, and may be accessible to the training engine 216 for use in training a class-based language model 218.

The one or more class-specific training samples repositories 214a-n includes one or more sets of class-specific text samples. Class-specific text samples generally relate to specific instances of classes such as the names of particular books, movies, or celebrities that may not be specifically included in the class-based training samples repository 212. In some implementations, class-specific training samples in the repositories 214a-n are obtained from terms that were substituted out of text samples to generate the class-based text samples. For example, an original text sample from text sample repository 202 may read “Has the temperature dropped below 80 this week in Arizona?” The named-entity recognition engine 206 may label the text sample: “Has the temperature dropped below <temperature>80</temperature> this week in <state> Arizona</state>?” The training samples generator 210 may then generate a class-based training sample that is stored in the class-based training samples repository 212: “Has the temperature dropped below $temperature this week in $state?” Finally, the terms that were substituted out to form the class-based training sample can be provided to the class-specific training samples repository 214, grouped into sets by class: “80” can be provided to a set of text samples for the “temperature” class, and “Arizona” can be provided to another set of text samples in repository 214 for the “state” class. In some implementations, by processing a large volume of text samples, many different terms that represent a wide variety of instances of various classes may be obtained in the class-specific training samples repository 214. In some implementations, all or some of the class-specific training samples may be obtained from the interconnected data structure 204. Names of entities in the data structure 204 may be added to respective sets of training samples in repository 214 according to classifications of the entities in the data structure 204. For example, a set of class-specific training samples relating to books may pull specific examples of book titles from either or both of text samples that had terms substituted out to form a book class-based text sample, and entities in the data structure 204 that also represent books.

The training engine 216 is configured to train one or more language models. The training engine 216 may be configured to generate new language models, to further train existing language models, or both. The training engine 216 may analyze a plurality of text samples to determine rules, signals, and probabilities for the sequences of terms and class identifiers as used in a language.

The training engine 216 may generate a class-based language model 218 and one or more class-specific language models 220a-n. A language model can include information that assigns probabilities to sequences of terms in a language. For example, based on the statistical analysis of text samples by the training engine 216, the language model may be capable of identifying that the sequence of terms “He is a fast talker” is less probable than “He is a fast walker,” but more probable than “He is a mast talker.” The class-based language model 218 can be trained on class-based text samples from the class-based training samples repository 212. The class-specific language models can be trained on the sets of class-specific training samples in repositories 214a-n. The class-based language model 218 may identify probabilities of sequences of terms in a language and class identifiers. For example, the class-based language model 218 may reflect a high probability that the next term in the sequence of terms “How many pages have you read in ?” is a term (or phrase) in a $book class. The class-based language model may not be trained on data that indicates specific instances of a class, but it is particularly configured to identify probabilities that a terms in a sequence of terms belong to a particular classes. By contrast, the class-specific language models 220a-n are trained on terms that represent specific instances of terms and entities in respective classes. Thus, for example, a first set of class-specific training samples in a book set may be used to train a book-specific language model 220, a second set of class-specific training samples in a movies set may be used to train a movies-specific language model 220, and so on. In some implementations, the class-specific language models 220a-n may be unlike the class-based language model and may not include information about probabilities of sequences of terms. In some implementations the class-specific language models 220a-n may comprise lists of terms within particular classes corresponding to respective class-specific language models 220a-n. For example, a books class-specific language model may comprise a list of book titles and a presidents class-specific language model may comprise a list of American presidents. The lists may be updated based on updated information about classes and entities in the data structure 204.

The class-based language model 218 and class-specific language models 220a-n may be used in one or more decoding applications 222. In some implementations, language models may be used in speech recognition, optical character recognition, and machine translation. A particular decoding application 222 may use both a class-based language model 218 and one or more class-specific language models 220a-n. For example, a speech recognizer that receives an utterance consisting of a sequence of words may use the language models 218, 220a-n to determine a most likely transcription of the utterance. The speech recognizer may use the class-based language model 218, to transcribe a likely partial sequence of terms, and when a likely class of terms is determined as being likely in the sequence, one or more class-specific language models 220a-n may be referenced to determine a most likely instance of the class in the utterance. For example, a user may speak “We are vacationing in the Rockies this summer.” The speech recognizer may use the class-based language model 218 to resolve the first portion of the utterance, “We are vacationing in.” The speech recognizer may determine that the next terms pertain to one or more classes, such as geographic locations or vacation spots. A list of such geographic locations or vacation spots may then be called upon from the class-specific language models 220a-n in order to determine the most likely specific instance of the class to use in transcribing the utterance.

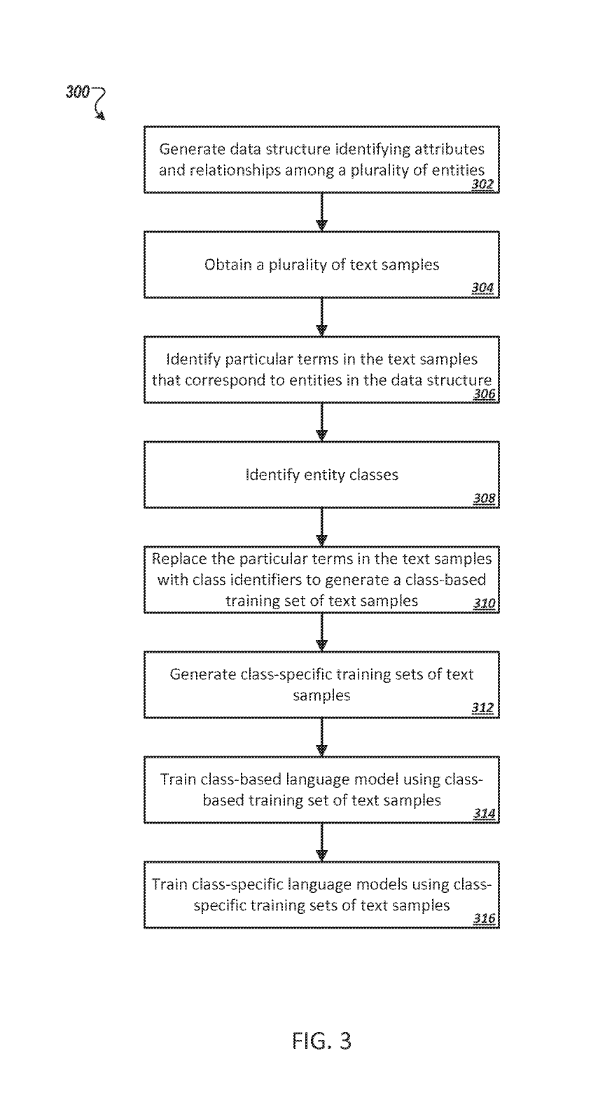

FIG. 3 depicts a flowchart of an example process 300 for training a class-based language model and one or more class-specific language models based on entities from a data structure of interconnected entities. In some implementations, the process 300 may be carried out in whole or in part by the systems described herein, including system 200 depicted in FIG. 2.

The process 300 may begin at stage 302 in which a data structure of interconnected entities is identified. The data structure may include information about a plurality of real world people, places, things, ideas, and more. Such people, places, things, and ideas may be represented as entities in the data structure. Entities in the data structure may have one or more attributes, and may be connected or otherwise related to one or more other entities in the data structure. For example, a first entity in the data structure may represent Harper Lee, a second entity may represent Truman Capote, and a third entity may represent the book “To Kill a Mockingbird.” The entities for Harper Lee and Truman Capote may each have one or more attributes such as birth dates, residence, accomplishments, etc. The two entities for these authors may also be connected through a relationship that they were childhood friends. Moreover, the entity for the book “To Kill a Mockingbird” may be connected to Harper Lee owing to the fact that Harper Lee. In some implementations, the data structure may be represented as a graph of nodes interconnected by edges, wherein the nodes are entities in the data structure and the edges indicate relationships and attributes of the entities. The data structure in process 300 may include all or any combination of the features of the data structures discussed elsewhere in this paper, such as data structures 104, 206, 500, and 602.

At stage 304, a plurality of text samples are obtained that can be used as the basis for training one or more language models. The text samples may be obtained from one or more sources such as query logs, speech transcription logs, and publicly available sources such as web pages and other online documents. The text samples may be selected so as to reflect a wide range of usage of terms and sequences of terms in a language.

At stage 306, one or more terms can be identified in the text samples that are determined to match entities in the data structure. In some implementations, the terms can be identified by named-entity recognition engine such as that depicted in system 200 of FIG. 2. The named-entity recognition engine may analyze the textual content of a text sample and any non-content based context information associated the text sample in order to determine whether the text sample includes any references to an entity in the data structure, and if so, to determine one or more entities that are most likely being referred to in the text sample. For example, in the sentence “Pomegranates are grown around the world from California and Arizona to Russia and Pakistan,” the process 300 may identify that the terms “Pomegranates,” “California,” “Arizona,” “Russia,” and “Pakistan,” all correspond to respective entities in the data structure for the pomegranate fruit, and the political geographic entities California, Arizona, Russia, and Pakistan.

At stage 308, the process 300 can identify classes for all or some of the terms in the text samples that are determined to likely match entities in the data structure. In some implementations, the text samples may be annotated with labels that identify the classes of particular terms. The classes may be determined based on classifications of the entities in the data structure that correspond to the terms in the text sample. For example, entities in the data structure that represent pomegranate, California, and Pakistan, respectively, may be classified as a fruit, state, and country, respectively. Therefore, the example text sample may be labeled with such classes: “<fruit>Pomegranates</fruit> are grown around the world from <state>California</state> and <state>Arizona</state> to <country>Russia</country> and <country>Pakistan</country>.” In some implementations, entities in the data structure may be assigned to multiple classes. For example, the entity representing pomegranates may be a fruit, flavor, tree, and food. Classification scores may be associated with each class that indicate the strength of the relationship of an entity to the each class. For example, the pomegranate may have classification scores of 80%, 30%, 70%, and 75% for the fruit, flavor, tree, and food classes, respectively. These classification scores may reflect that statistically, most references to a pomegranate are to its significance as a fruit in contrast to the equally true fact that it is also a flavor, tree, and food generally. In some implementations, the process 300 can label terms in a text sample with the most relevant classification such as the class having the highest classification score. In some implementations, the process 300 can label a term with multiple classes such as the several classes having the top classification scores that exceed at least a threshold classification score.

At stage 310, the process 300 includes replacing particular terms in the text samples with class identifiers to generate a class-based training set of text samples. Terms that were labeled in the text samples by a named-entity recognition engine in stage 308 may be replaced with class identifiers. For example, the labeled text sample “<fruit>Pomegranates</fruit> are grown around the world from <state>California</state> and <state>Arizona</state> to <country>Russia</country> and <country>Pakistan</country>” may be modified to generate the class-based training sample “$fruits are grown around the world from $state and $state to $country and $country.” At stage 312, class-specific training sets of text samples are generated. In some implementations, the class-specific training sets of text samples include terms that were substituted out of the original text samples to generate the class-based training sets of text samples. For example, “pomegranate” may be placed in a fruit-specific training set of text samples, “California” and “Arizona” may be placed in a state-specific training set of text samples, and “Russia” and “Pakistan” may be placed in a country-specific training set of text samples. The class-specific training sets of text samples may also include additional instances of respective classes identified from entities in the data structure that are assigned to particular classes. For example, additional fruits may be added to the fruit-specific training set by looking up other fruit entities in the data structure and additional states may be added to the state-specific training set by looking up other states entities in the data structure.

As stage 314, the process 300 trains a class-based language model based on the class-based training set of text samples. A training engine may statistically analyze the class-based training set of text samples to determine probabilities of sequences of terms and class identifiers. At stage 316, the process 300 trains one or more class-specific language models based on the class-specific training sets of text samples. In some implementations, the class-specific language models may be lists of terms that are determined to belong to particular classes.

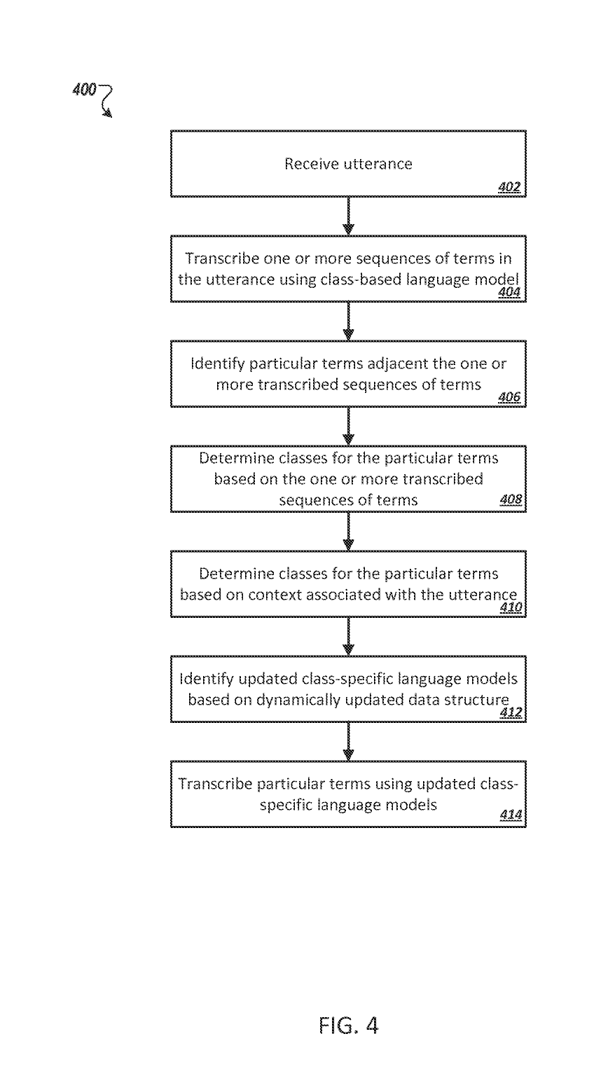

The language models that were trained in process 300 may be used in various applications, including speech recognition, machine translation, optical character recognition, and others. In FIG. 4, an example process 400 is depicted for using a class-based language model and one or more class-specific language models in a speech recognizer. The speech recognizer may generally be configured to transcribe speech samples into text. At stage 402, an utterance is received. For example, a user may speak “Remind me that Tom Francis will be in town next week” into the user's mobile device (e.g., smartphone, tablet, notebook computer) in order to command the device to set a reminder about Tom's arrival. The device may detect the utterance and generate a digital audio sample for the utterance.

At stage 404, the process 400 transcribes one or more sequences of terms in the utterance using the class-based language model. In some implementations, a local or remote speech recognizer may analyze the audio sample for the utterance to determine one or more likely terms in the utterance. The speech recognizer may determine the most likely terms and most likely sequence of terms in the utterance based on probabilities of sequences of terms defined by the class-based language model. For example, the speech recognizer may transcribe the first portion of the utterance using the class-based language model and the end portion of the utterance: “Remind me that______will be in town next week.” Based on the context of the transcribed portion of the utterance, the class-based language model may determine that the words between “Remind me that” and “will be in town next week” relates to an instance of a person class. The determination may be made at stage 406 by identifying particular terms that are adjacent to the one or more initially transcribed sequences of terms, and at stage 408, by determining one or more classes for the particular terms based on the one or more transcribed sequences of terms. In some implementations, a class for particular terms may also be determined, at stage 410, using one or more non-content-based context signals such as user profile information that indicates the user's interests.

At stage 412, the process 400 identifies one or more class-specific language models to transcribe specific instances of classes in the utterance. For example, in the partial transcription of the utterance “Remind me that______will be in town next week,” the class-based language model may determine that the non-transcribed terms in the utterance relate to a person's name. However, the class-based training model may be trained to determine one or more likely classes for dynamic, highly specific terms, but may not be configured to recognize the specific terms within a class. Accordingly, the process 400 can use one or more class-specific language models to transcribe the specific terms. The particular class-specific language models selected to transcribe a term may be selected based on the one or more likely class identifiers for the term that were identified by the class-based language model. For example, one class-specific language model may be directed to people and include the names of many people.

At stage 414, the specific terms in the text sample may be transcribed using the identified class-specific language models. For example, acoustic data from the audio file may be determined to most closely match the names “Tom” and “Francis” in the “persons” class-specific language model. In some implementations, multiple class-specific language models may be accessed to transcribe class-specific terms. For example, based on the context of the text sample, the class-based language model may determine that there is at least a threshold likelihood that terms in a text sample belong to either a “person” class or a “celebrity” class. Therefore, both a “person” class-specific language model and a “celebrity” class-specific language model may be checked to determine the best transcription for the class-specific terms in the text sample. In some implementations, the class-based language model may identify a particular class that a term in a text sample likely belongs to, and in response, multiple related class-specific language models may be accessed that correspond to the particular class. For example, the class-based language model may determine that the missing terms in the partially transcribed utterance “Remind me that will be in town next week” relate to a “person” class. In response, class-specific language models related to both “persons” generally and more specific classes of people such as “athletes,” “politicians,” and celebrities may all be accessed, as well, to transcribe the utterance.

The term or phrase selected from the class-specific language models may be influenced by one or more signals that indicate a context of the user. In some implementations, such context signals may be applied to adjust the probabilities that terms or phrases within a class-specific language model match the class-based term or phrase in the input stream. For example, a person located in Orlando, Fla. may speak “How do I get to Sea World from here?” into a navigation app on a mobile device that uses a speech recognizer and language model to transcribe the input stream. Based on the terms surrounding “Sea World,” a class-based language model in the speech recognizer may determine that the terms falling between “How do I get to” and “from here” belong to a “location” class. Accordingly, a “location” class-specific language model is accessed. The audio features of the input stream alone may indicate that the probability of the class terms being “Sea World” is 45 percent, for example. But given that the person is geographically located in Orlando, Fla., this location information can be used as a context signal to boost the probability of Sea World to, say, 75 percent. In some implementations, information stored within the data structure of interconnected entities (e.g., knowledge database) may indicate how the probabilities of terms for the various entities within a class-specific language model should be adjusted. For example, the data structure may include the geographical locations of the places referred to within the “location” language model. Those locations may be compared to the user's geographic location, and then the places that are closest to the user's geographic location may be afforded a higher probability than those places that are further from the user.

Context signals other than, or in addition to, location may also apply when selecting terms or phrases from a class-specific language model. For example, personalized information from a user profile may indicate the user's interests. Based on the profile information, terms or phrases may be selected from the class-specific language model that align with the user's interests. Thus, the user's profile information may indicate that he or she is deeply interested in classic Spanish art. Accordingly, when accessing a class-specific language model for “artists,” the Spanish artists Francisco de Zurbarán, Diego Velázquez, and El Greco may be weighted higher to increase their chance of selection over artists who do not meet the classic Spanish art criterion. Again, a knowledge database or other data structure that represents information and relationships among real-world entities may be referenced by the class-specific language model to determine the appropriate weights based on facts stored in the database. Other context signals may include, for example, highly granular location information (e.g., promote entities that are associated with specific locations such as Andrew Luck when the user is in Lucas Oil stadium, the home of the Indianapolis Colts).

In some implementations, the class-specific language models may be dynamically generated based on user context signals. One or more context signals may be converted to a query and run on the knowledge database to identify potentially relevant entities. Among the entities that are returned as results to the query, one or more may be finally selected to transcribe the input stream. By way of example, a user who sends a text from the Louvre Museum in Paris, France may speak “I am viewing the most incredible painting by Andrea Mantegna right now” into a speech recognizer, which uses language models to transcribe the utterance to text. The class-based language model may detect that the words following the phrase “painting by” most likely belongs to an “artist” class. Based on the user's detected geographic location, it can be determined that the user is at the Louvre Museum. Accordingly, a search may be performed on the knowledge database for artists whose work is on display at the Louvre. A class-specific language model may then be dynamically created that includes those artists whose work is displayed at the Louvre. Other artists who do not meet the requisite criteria may be excluded from the language model in this instance. Dynamic generation of class-specific language models may be performed in addition, or alternatively, to techniques for re-weighting the probabilities of entities within pre-defined class-specific language models, as described above.

FIG. 5 is a data graph 500 in accordance with an example implementation of the techniques described herein. The data graph 500 may represent the storage and structure of information in a data structure of interconnected entities. Such a data graph 500 stores information related to nodes (entities) and edges (attributes or relationships), from which a graph, such as the graph illustrated in FIG. 5 can be generated. The nodes 502 may be referred to as entities, and the edges 504 may be referred to as attributes, which form connections between entities.

FIG. 6 depicts an example portion of a data structure 602 of interconnected entities. In some implementations, the data structure 106 may store information about entities in the data structure in the form of triples. For example, triples 350 identify a subject, property, and value in the triples. Tom Hanks is an entity in the data structure 602 and is the subject of the triples. A first of the triples 350 identifies the property ‘has profession,’ and a second of the triples 350 identifies the property ‘has spouse.’ The value of the property is the third component of the triples. Tom Hanks has profession ‘Actor’ and has spouse ‘Rita Wilson.’ In the first of the triples 350, the property (attribute) has a value that is a fact in the data structure. Actor may or may not be an entity in the data structure, for example. In some implementations, the value component of the triplet may reference a classification of the entity (e.g., Actor) from which a named-entity recognition engine can determine a class for an entity mentioned in a text sample. In the second of the triples 350, the value component is another entity in the data structure 602, particularly the entity for Rita Wilson. Thus, the triple 350 specifies that the entity for Tom Hanks is connected or related to the entity for Rita Wilson by a spousal relationship. Additional triples, and their conversely related triples are shown in triples 360, 300, and 300′.

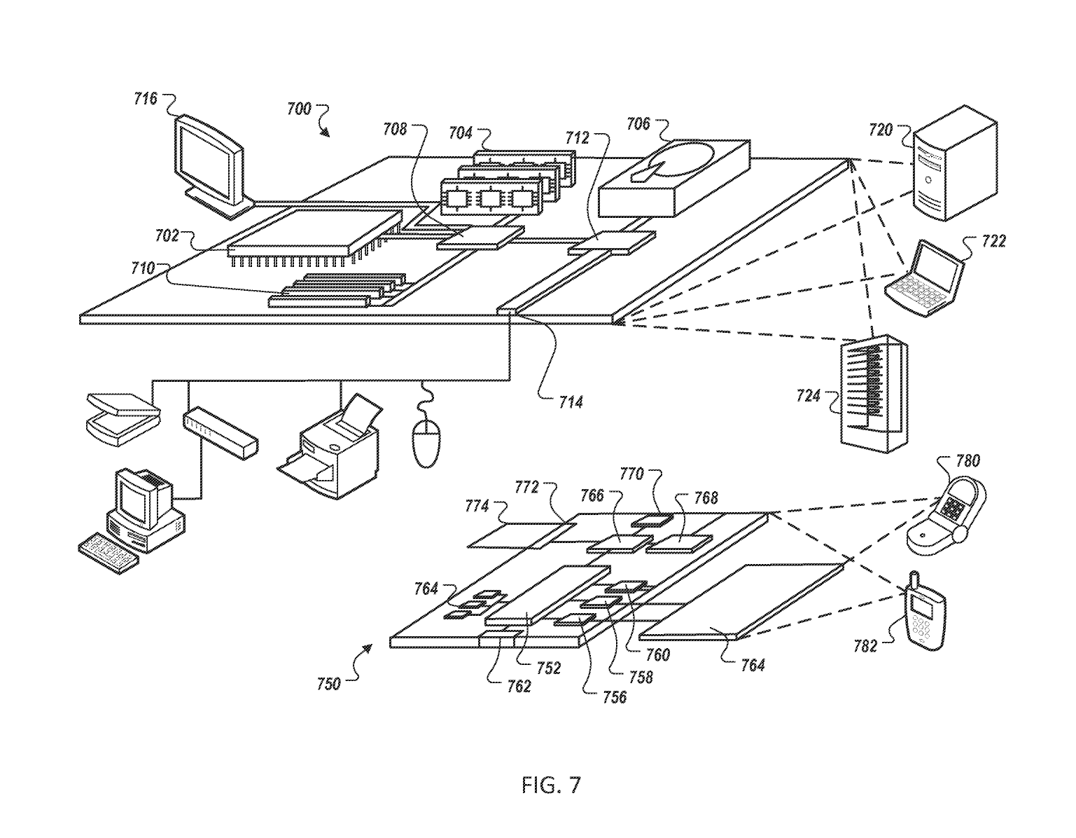

FIG. 7 shows an example of a computing device 700 and a mobile computing device that can be used to implement the techniques described herein. The computing device 600 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. The computer program product may also contain instructions that, when executed, perform one or more methods, such as those described above. The computer program product can also be tangibly embodied in a computer- or machine-readable medium, such as the memory 704, the storage device 706, or memory on the processor 702.

The high-speed interface 708 manages bandwidth-intensive operations for the computing device 700, while the low-speed interface 712 manages lower bandwidth-intensive operations. Such allocation of functions is exemplary only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device (not shown), such as a mobile computing device 750. Each of such devices may contain one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above, and may include secure information also. Thus, for example, the expansion memory 774 may be provide as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. The computer program product contains instructions that, when executed, perform one or more methods, such as those described above. The computer program product can be a computer- or machine-readable medium, such as the memory 764, the expansion memory 774, or memory on the processor 752. In some implementations, the computer program product can be received in a propagated signal, for example, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 768 using a radio-frequency. In addition, short-range communication may occur, such as using a Bluetooth, WiFi, or other such transceiver (not shown). In addition, a GPS (Global Positioning System) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in the figure. For example, it may be implemented as a cellular telephone 780. It may also be implemented as part of a smart-phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although various implementations have been described in detail above, other modifications are possible. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method, comprising:
obtaining a plurality of text samples;
for each of one or more text samples in the plurality of text samples:
determining that at least one term in the text sample corresponds to a first entity in a data structure of entities, wherein the data structure includes representations of a plurality of entities and defines relationships among particular ones of the plurality of entities;
determining classes to which the first entity within the data structure of entities belongs; and
annotating the text sample with one or more labels that indicate respective classes to which the first entity corresponding to the at least one term belongs;
generating a class-based training set of text samples by substituting the one or more terms in the one or more text samples with respective class identifiers for the one or more terms that correspond to the respective labels for the one or more terms;
training a class-based language model using the class-based training set of text samples;
training a plurality of class-specific language models; and
performing speech recognition on an utterance using the class-based language model and at least one class-specific language model from among the plurality of class-specific language models.

2. The computer-implemented method of claim 1, wherein the data structure of entities is represented by a graph of interconnected nodes that correspond to respective entities represented in the data structure.

3. The computer-implemented method of claim 1, wherein annotating the text sample comprises identifying multiple classifications for the first entity, and selecting a particular classification from among the multiple classifications that the first entity is most strongly associated with.

4. The computer-implemented method of claim 1, wherein the data structure of entities maps relationships among entities in the data structure and identifies one or more attributes of particular ones of the entities in the data structure.

5. The computer-implemented method of claim 4, further comprising determining that a second term in a first text sample being annotated corresponds to a first attribute of one or more entities in the data structure of entities, wherein annotating the first text sample comprises determining a label for the second term in the first text sample based on the first attribute of the one or more entities in the data structure.

6. The computer-implemented method of claim 1, further comprising generating a plurality of class-specific training sets of text samples using terms from the one or more text samples that were substituted out for the class identifiers in the class-based training set of text samples,
wherein one or more class-specific language models from among the plurality of class-specific language models are trained using class-specific training sets of text samples.

7. The computer-implemented method of claim 1, further comprising repeatedly re-training the plurality of class-specific language models using dynamically updated training sets of text samples.

8. The computer-implemented method of claim 7, wherein the dynamically updated training sets of text samples used to repeatedly re-train the plurality of class-specific language models are generated using entities identified from a data structure of entities.

9. The computer-implemented method of claim 8, wherein the data structure of entities is an emergent data structure that reflects updated knowledge over time such that additional entities are identified from the data structure for at least some of the times that the updated training sets of text samples are generated.

10. The computer-implemented method of claim 1, wherein performing speech recognition on the utterance using the class-based language model and the at least one class-specific language model comprises:
transcribing, using the class-based language model, one or more sequences of terms in the utterance;
identifying a particular term in the utterance that is adjacent to the one or more sequences of terms in the utterance that have been transcribed;
determining, based on the one or more sequences of terms in the utterance that have been transcribed, one or more classes to which the particular term likely belongs; and
transcribing the particular term using the at least one class-specific language model, wherein the at least one class-specific language model is selected based on the one or more classes to which the particular term is determined to likely belong.

11. The computer-implemented method of claim 10, wherein the one or more classes to which the particular term likely belongs are determined further based on one or more contextual signals associated with the utterance other than content of the utterance.

12. The computer-implemented method of claim 10, wherein transcribing the particular term using the at least one class-specific language model comprises determining that the particular term is an entity or an attribute of an entity in a data structure of entities.

13. The computer-implemented method of claim 1, wherein performing speech recognition on the utterance comprises generating a transcription of the utterance and labeling one or more terms in the transcription based on one or more class-specific language models that were used to transcribe respective ones of the one or more terms.

14. The computer-implemented method of claim 13, wherein the one or more terms in the transcription are labeled with respective classes for the one or more terms that correspond to classes of entities in a data structure of entities.

15. One or more computer-readable devices having instructions stored thereon that, when executed by one or more processors, cause performance of operations comprising:
obtaining a plurality of text samples;
for each of one or more text samples in the plurality of text samples:
determining that at least one term in the text sample corresponds to a first entity in a data structure of entities, wherein the data structure includes representations of a plurality of entities and defines relationships among particular ones of the plurality of entities;
determining classes to which the first entity within the data structure of entities belongs; and
annotating the text sample with one or more labels that indicate respective classes to which the first entity corresponding to the at least one term belongs;
generating a class-based training set of text samples by substituting the one or more terms in the one or more text samples with respective class identifiers for the one or more terms that correspond to the respective labels for the one or more terms;
training a class-based language model using the class-based training set of text samples;
training a plurality of class-specific language models; and
performing speech recognition on an utterance using the class-based language model and at least one class-specific language model from among the plurality of class-specific language models.

16. The one or more computer-readable devices of claim 15, wherein the data structure of entities is represented by a graph of interconnected nodes that correspond to respective entities represented in the data structure.

17. The one or more computer-readable devices of claim 15, wherein performing speech recognition on the utterance using the class-based language model and the at least one class-specific language model comprises:
transcribing, using the class-based language model, one or more sequences of terms in the utterance;
identifying a particular term in the utterance that is adjacent to the one or more sequences of terms in the utterance that have been transcribed;
determining, based on the one or more sequences of terms in the utterance that have been transcribed, one or more classes to which the particular term likely belongs; and
transcribing the particular term using the at least one class-specific language model, wherein the at least one class-specific language model is selected based on the one or more classes to which the particular term is determined to likely belong.

18. The one or more computer-readable devices of claim 17, wherein transcribing the particular term using the at least one class-specific language model comprises determining that the particular term is an entity or an attribute of an entity in a data structure of entities.

19. A system, comprising:
one or more computers configured to provide:
a data structure that includes representations of a plurality of entities and that maps relationships among particular ones of the plurality of entities;
an entity classifier that assigns particular entities from among the plurality of entities in the data structure to one or more respective classes;
one or more corpora of text samples;
a named-entity recognition engine that identifies particular terms in a first set of text samples that correspond to entities represented in the data structure;
a training sample generator that generates a training set of text samples by replacing the particular terms in the first set of text samples with class identifiers that indicate respective classes for the particular terms that are determined based on the classes that the entity classifier has assigned to the entities represented in the data structure that correspond to the particular terms; and
a training engine that generates one or more language models using the training set of text samples.

20. The system of claim 19, wherein the training engine generates a class-based language model using the training set of text samples and one or more class-specific language models using the particular terms that were substituted out of the training set of text samples.
